(19) United States
(12) Patent Application Publication
(10) Pub. No.: US 2022/0370298 A1
(43) Pub. Date: Nov. 24, 2022

(54) INFANT PACIFIER WITH EXTERNAL FEEDING PATHWAY

(71) Applicant: Barbara O'Rourke, Ames, IA (US)

(72) Inventor: Barbara O'Rourke, Ames, IA (US)

(21) Appl. No.: 17/663,938

(22) Filed: May 18, 2022

Related U.S. Application Data
(60) Provisional application No. 63/201,904, filed on May 18, 2021.

(51) Int. Cl. A61J 17/00

(52) U.S. Cl. CPC A61J 17/107

(57) ABSTRACT

A pacifier is provided with an enlarged guard to rest against a premature baby's lips, and a nipple with a base, a narrow neck, and a bulbous tip. A hole is provided in the guard, and communicates with an open channel or pathway formed on the exterior surface of the nipple base. Milk drops from a syringe or other source can be introduced through the hole to the channel, and then flow into the baby's mouth. This introduction of milk along the pacifier into the premature infant's mouth helps the premature infant to learn sucking and swallowing, even while being fed through a nasal tube.

### CROSS REFERENCE TO RELATED APPLICATIONS

This application claims priority under 35 U.S.C. § 119 to provisional patent application U.S. Ser. No. 63/201,904, filed on May 18, 2021. The provisional patent application is herein incorporated by reference in its entirety, including without limitation, the specification, claims, and abstract, as well as any figures, tables, appendices, or drawings thereof.

### TECHNICAL FIELD

The present invention relates to the feeding of premature infants, the assisted development and/or coordination of the suck, swallow, breathe (SSB) synchrony, and the resolution of feeding difficulties commonly seen in these infants.

### BACKGROUND OF THE INVENTION

The A premature birth, also called a preterm birth, is defined as birth within the first 37 weeks of gestation. According to the Division of Reproductive Health, National Center for Chronic Disease Prevention and Health Promotion, one out of every nine infants in the United States will be born prematurely of the approximate 500,000 infants delivered each year. The significance being that these premature infants cost the U.S. health care system more than $26 billion each year.

Statistically, in the United States, the majority of babies born prematurely at thirty-five or less weeks of gestation will be admitted to a Neonatal Intensive Care Unit (NICU). The immaturity of the premature infant in all aspects makes him especially vulnerable.

Preterm babies accounted for 35% of the infant deaths in 2008. The American College of Obstetricians and Gynecologists has indicated that premature babies are also at a much higher risk of many serious long-term complications.

These complications include:
Respiratory distress syndrome (RDS)
Intracranial bleeding
Infection
Gastrointestinal disorders, including poor feeding
Temperature control
Vision and hearing problems
Neurological disabilities including cerebral palsy
Developmental delays

Feeding premature infants often is a challenge for both medical staff and parents. The developmental process of feeding starts in utero, as the fetus begins to suck at approximately fifteen to sixteen weeks of gestation. Swallowing is also developing around the same time at the age of fourteen to seventeen weeks. Swallowing is a complicated process involving twenty-six muscles and six major nerves all working together in a coordinated, timely fashion. The fetus may swallow up to 15 ounces of amniotic fluid a day.

The coordination to suck, swallow, and breathe (“SSB”) while bottling or breastfeeding is an important and necessary milestone for the infant to feed successfully and safely. The SSB synchrony begins to develop at approximately thirty-one to thirty-three weeks of gestation, and only matures at approximately thirty-seven to thirty-eight weeks. These fundamental coordinated skills are significantly more difficult for the premature infant.

The NICU attempts to replicate the in utero experience for premature infants, in many ways, by giving them boundaries and dark quiet surroundings, but the practice and enjoyment of swallowing the amniotic fluid is halted. Once the premature infant is born, the functions of these body parts are temporarily put on hold until the infant is medically capable and developmentally mature enough to coordinate his (SSB).

Initially, a feeding tube will be inserted to start the process of feeding. Milk is given through the feeding tube, bypassing the mouth. At the same time the infant is only allowed to suck on a non-nutritive pacifier.

During this early phase in the feeding process, the esophagus and cardiac sphincter of the stomach are basically inactive since only saliva is being swallowed by the infant. In addition, feeding tubes remain in place for weeks, thus resulting in the cardiac sphincter remaining partially open for prolonged periods of time. The use of feedings tubes has been shown to double the likelihood of esophageal reflux in the premature infant.

The premature infant also has a premature brain. Nerve pathways are being wired in response to every experience. Medical protocol will often require the premature infant to undergo obtrusive oral procedures. These procedures may include intubation, suctioning, placement of feeding tubes, and even oral cares is somewhat obtrusive. The infant may begin to associate that anything done orally as unpleasant. It has been shown, that repetitive oral experiences, whether good or bad, are establishing neural mapping and feeding associations. If these associations are negative, it may affect the infant's ability and desire to eat both in the NICU and after discharge from the hospital.

There exists an added concern. Research recently completed by the Institute of Psychiatry at King's College London, indicated “a very strong link” exists between premature birth and mental health disorders. The results are consistent with a 1999 study, published in the American Medical Association's Archives of General Psychiatry. In sum, this research suggests that subtle alterations in the brain development of those born prematurely may play an important role in mental health later in life.

Accordingly, a primary objective of the present invention is the provision of an improved pacifier to safely and easily introduce droplets of milk into the mouth of a premature infant.

A further objective of the present invention is the provision of a premature infant pacifier designed specifically for premature infants to coordinate sucking, swallowing and breathing.

Yet another objective of the present invention is the provision of a method of providing milk to a premature infant via a pacifier which allows the premature infant to safely experience sucking and swallowing as the infant develops and matures.

Another objective of the present invention is the provision of a pacifier for premature babies having an exterior pathway through which milk drops are directed into the infant's mouth.

Another objective of the present inventions is the provision of a pacifier which allows a premature infant to continue the enjoyable oral experiences of sucking and swallowing as they did in utero.

Another objective the present invention is the provision of a controlled method administered by caregivers to a premature infant that allows the premature infant to safely practice the coordination of sucking, swallowing, and breathing.

Another objective the present invention is the provision of a method of simultaneously gavage feeding a premature infant and orally giving milk drops to the infant to help the infant associate hunger, oral enjoyment, and satiation with being fed.

These and other objectives become apparent from the following description of the invention.

### SUMMARY

A pacifier is designed to introduce milk droplets into a premature infant's mouth through an open channel on the exterior of the pacifier. The pacifier includes a guard and a nipple, with the nipple having a base, reduced-diameter neck, and an enlarged diameter bulbous tip. The channel intersects with a hole through the guard, and extends along the nipple base to the neck. As the premature infant sucks on the pacifier, milk can be introduced through the hole in the guard to the channel, which directs the milk to the baby's mouth. The location of the channel on the exterior of the pacifier allows a caregiver to visually observe the flow of the milk droplets into the baby's mouth. This pacifier can be used simultaneously with gavage or tube feeding of the baby through his/her nose.

This method of introducing milk drops into the infant's mouth via the pathway on the exterior surface of the nipple base allows the infant to safely experience sucking and swallowing as the infant develops and matures.

### BRIEF DESCRIPTION OF THE DRAWINGS

FIG. 1 is a perspective view of the pacifier according to the present invention having an exterior channel for milk flow into a premature infant's mouth during use of the pacifier.

FIG. 2 is a perspective view of the pacifier shown in FIG. 1.

FIG. 3 is a bottom view of the pacifier shown in FIG. 1.

FIG. 4 is a right view of the pacifier shown in FIG. 1.

FIG. 5 is a left view of the pacifier shown in FIG. 1.

FIG. 6 is a front view of the pacifier shown in FIG. 1.

FIG. 7 is a back view of the pacifier shown in FIG. 1.

FIG. 8 is a top view of the pacifier shown in FIG. 1.

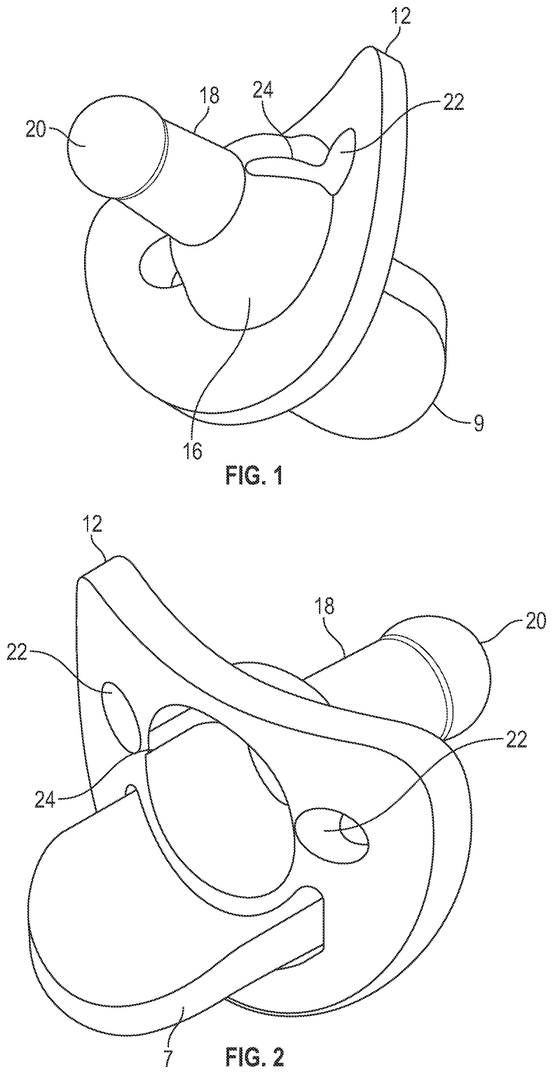

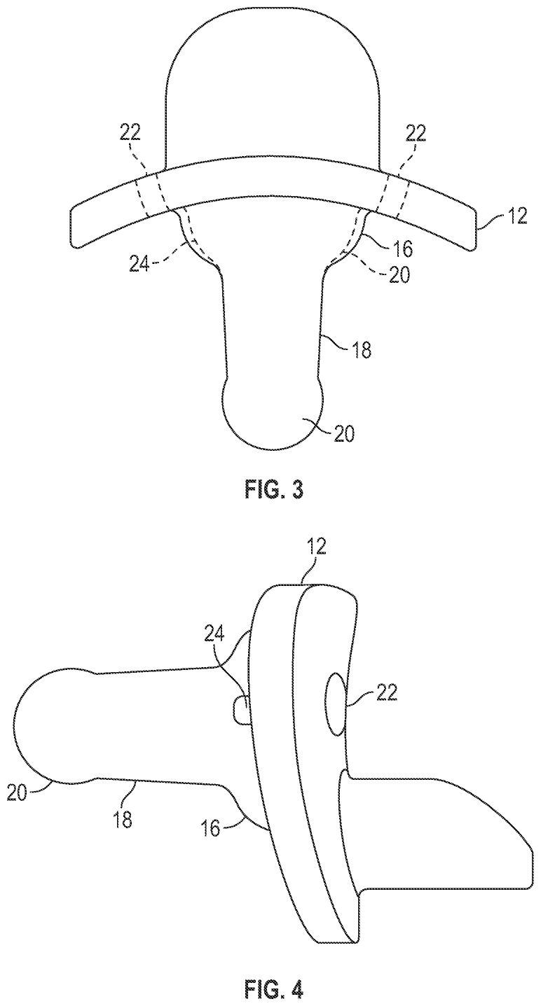

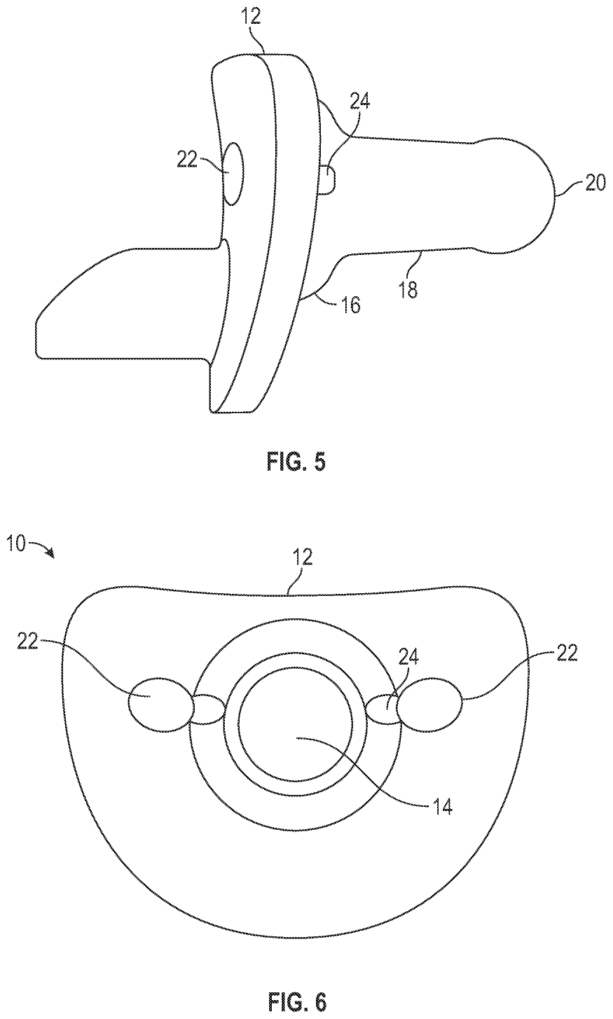

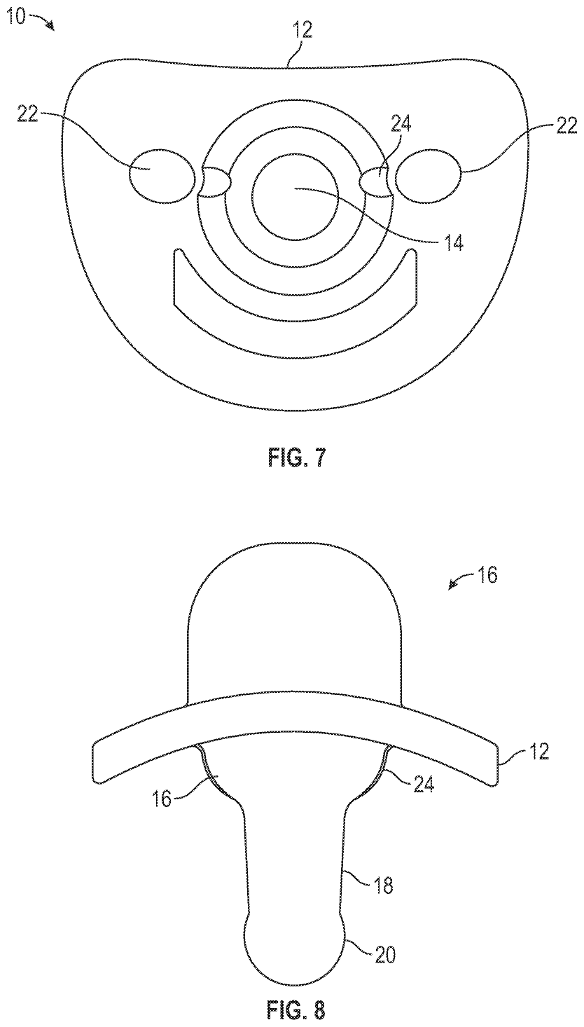

### DETAILED DESCRIPTION

The goal of this invention, in all embodiments, is to allow the premature infant to continue the developmental, enjoyable in utero experience of sucking and swallowing that was in process at the time of the infant's premature birth.

To accomplish this goal, a process and feeding apparatus have been developed that provides the premature infant with the oral pleasure of sucking and swallowing, at the same time giving the infant the opportunity to practice the synchrony of SSB. This process allows the infant to enjoy feedings rather than becoming overwhelmed by allowing the caregiver to control the timing and the amount of milk given orally. Thus, the infant will associate positive neural connections to feedings. In addition, the process also allows the esophagus and cardiac sphincter to actively function while feedings are still being given through the feeding tube.

Historically, premature infants are fed through a feeding tube until developmentally they are mature enough to coordinate their SSB. In transitioning to oral feedings, the infant, who up to this point has not had any milk orally, now pulls a bolus of milk into his mouth. This bolus is often overwhelming to the infant. The infant does not know what to do. In response, the infant may stop breathing, drop his heartrate, and drop his oxygen levels. If this type of experience continues or the infant is pushed to eat the infant may shutdown and stop feeding altogether.

It takes time for the infant to develop and mature before he is able to suck, manage the bolus, swallow, and breathe. While the infant is maturing, he is also struggling with many negative invasive oral experiences associated with routine NICU care. The transition from gavage to oral feeding is challenging with many infants staying longer in the NICU to achieve oral feeding competence. The present invention seeks to allow the infant to again experience oral enjoyment by giving drops of milk in a controlled manner, and based on the infant's response. As the infant “practices”, he becomes “more experienced” and gradually “learns” how to manage more milk while benefitting from the enjoyable oral experience of sucking and swallowing.

The pacifier of the present invention is generally designated in the drawings by the reference numeral 10. The pacifier 10 includes a guard 12 and a nipple 14. The guard 12 normally rests upon the infant's lips when the nipple 14 is in the infant's mouth. The nipple 14 generally includes a bulbous base 16, a narrowed neck 18, and a bulbous tip 20.

The guard 12 includes at least one air vent hole 22 which aids in breathing while the infant is using the pacifier 10. The base 16 of the nipple 14 includes an open pathway, channel, or groove 24 which extends from a first rear end adjacent the air vent 22 to a second forward end on or near the neck 18 of the nipple 14. The air vent 22 functions as a funnel to allow milk drops to be directed onto the channel 24 and flow along the exterior pathway of the nipple 14 into the infant's mouth as the infant sucks on the pacifier. Since the milk drops flow along the outside of the nipple 14, a parent, nurse, or other person can visually observe the milk flowing into the infant's mouth and assess the infant's response to the milk drops without manipulating or moving the pacifier 10. This prevents disturbing the infant's sucking pattern, thus allowing the experience to be uninterrupted and enjoyable.

The channel 24 in the nipple 14 can be formed in any convenient manner. Preferably, the channel 24 is formed as the nipple 14 is formed, by molding or other manufacturing processes for the nipple. Alternatively, the channel 24 can be retrofit on the exterior of the nipple, after the nipple is formed, by cutting the channel or groove 24 into the exterior surface of the nipple 14. Preferably the channel 24 terminates at the rear end of the nipple neck 18 at or near the juncture of the base 16 and the neck 18, but alternatively can extend partially along the neck 18. The channel 24 should not extend into the bulbous nipple tip 20, since such an extension would introduce the milk droplets too deeply in the baby's mouth.

Milk, more preferably mother's breast milk, is given through the channel 24 of the pacifier 10 in a controlled manner, by use of a syringe or other controlled dispensing means. Initially the very premature infant may only be given one or two drops of milk on the pacifier 10. As the infant sucks, the caregiver responds by giving additional drops of milk as tolerated by the infant. The process is stopped if the infant ceases to suck or responds with a drop-in heart rate, oxygenation, or stops breathing. There are no forced feeding attempts. The focus and goal of these experiences is safety and enjoyment of the infant. The pacifier 10 provides a simple method for introducing milk drops for the infant to swallow, while easily visualizing the infant's response by an observer.

When the infant begins to be fed through the feeding tube, the specialized pacifier 10 will be offered to the infant to start the enjoyable association of tasting, sucking, and swallowing while being fed. As the infant becomes more experienced and mature, he begins to suck longer, and the volume of the milk given orally via the pacifier 10 may be increased. The infant gradually begins to coordinate his SSB during feeding without becoming stressed or tired. When the infant stops sucking, the process is stopped, and the balance of the feeding is given through the feeding tube. This enjoyable oral experience thus promotes the positive neural connection of being satisfied to feeding.

An important additional benefit is that the process requires the caregiver to become more involved and spend time with the infant as they actively engage and respond to the infant sucking and swallowing. This bonding activity between infant and caregiver may have long term significance to the wiring of neural connections related to nurturing and socialization that are also being developed by the premature brain.

In experimentation, it has been found that when using the modified pacifier 10 and, following the process as stated, the premature infant's heart rate, respiratory rate, and oxygen levels remain stable. The infant is calm and sucks eagerly. Additionally, it has been hypothesized that use of this invention may provide a sensory-motor experience that leads to earlier SSB coordination. This skill allows the infant to enjoy his feeding and make positive developmental strides both physically and neurologically. Ultimately the infant may be able to safely nurse and bottle sooner with earlier discharge home.

The embodiments, variations, and figures described above are provided as an indication of the utility and versatility of the present invention. Other embodiments that do not provide or otherwise utilize all of the features, processes and advantages set forth herein may also be utilized, without departing from the spirit and scope of the present invention. Such modifications and variations are considered to be within the scope of the principles of the invention as defined by the claims set forth below.

What is claimed is:

1. A pacifier for teaching sucking and swallowing to a premature infant, comprising:
a guard;
a nipple extending from the guard and having a base, a narrowed neck, and a tip, the nipple being adapted for the premature infant's mouth;
a hole though the guard adjacent an exterior surface of the nipple base; and
a recessed pathway formed on the exterior surface of the nipple base to direct milk drops provided through the hole and along the nipple base into the mouth of the premature infant.

2. The pacifier of claim 1 wherein the path is an open channel on the exterior of the nipple base.

3. The pacifier of claim 1 wherein the hole is an air vent.

4. The pacifier of claim 1 wherein the hole funnels milk to the path.

5. The pacifier of claim 1 wherein the pathway terminates at the neck of the nipple.

6. The pacifier of claim 1 wherein the pacifier includes a second hole in the guard for passage of air.

7. The pacifier of claim 1 wherein the hole and the pathway intersect one another.

8. The pacifier of claim 1 wherein the pathway extends only along the base of the nipple.

9. The pacifier of claim 1 wherein the pathway extends from a front surface of the guard to the neck of the nipple.

10. The pacifier of claim 1 wherein the pathway is visible to an observer without moving the pacifier in the infant's mouth.

11. A method which allows a premature infant to safely experience sucking and swallowing as the infant develops and matures, comprising:
placing a pacifier into the infant's mouth, the pacifier having a guard and a nipple;
introducing milk drops into the infant's mouth though a hole in the guard onto a pathway on the exterior surface of a nipple for entry into the infant's mouth.

12. The method of claim 11 further comprising enterally feeding the infant through a feeding tube while the infant orally receives milk drops by way of the pacifier.

13. The method of claim 12 wherein the milk flows along an open channel on the exterior of the nipple for entry into the infant's mouth.

14. The method of claim 11 wherein the infant's reaction to the milk is observed without moving the pacifier.

15. The method of claim 11 wherein the nipple has a base, a reduced-diameter neck, and an enlarged forward end, and the milk drops flow along the channel to the neck of the nipple.

16. A premature infant pacifier to coordinate sucking, swallowing and breathing in a premature infant, comprising:
a guard for engaging the infant's lips, and having a hole extending therethrough;
a nipple with a base adjacent the guard, and bulbous tip, and a narrowed neck between the base and the tip;
a channel formed in the base of the nipple and adapted to direct milk introduced through the hole in the guard into the infant's mouth via the channel.

17. The pacifier of claim 16 wherein the channel is molded into the base of the nipple.

18. The pacifier of claim 16 wherein the channel extends along the base to the neck of the nipple.

19. The pacifier of claim 16 wherein the channel has an open top to allow external visual inspection of flow of milk along the channel.

20. The pacifier of claim 16 wherein the channel has a rearward end intersecting with the hole in the guard.
